(19) United States
(12) Patent Application Publication
(10) Pub. No.: US 2008/0103908 A1
(43) Pub. Date: May 1, 2008

(54) E-commerce Epicenter Business System

(76) Inventor: Aaron J. Munk, Lakewood, NJ (US)

Correspondence Address: ISRAEL NISSENBAUM, 1038-56TH ST, BROOKLYN, NY, 11219, US

(21) Appl. No.: 11/924,570

(22) Filed: Oct. 25, 2007

Related U.S. Application Data
(60) Provisional application No. 60/862,885, filed on Oct. 25, 2006.

(51) Int. Cl. G06Q 30/00; G06Q 90/00

(52) U.S. Cl. 705/14

(57) ABSTRACT

A marketing system comprising a personal design center designed to enable depiction of customer selected choices of modified parts of actual photos of design options overlaid on existing reality images with color display and with selectable groupings of the customer selected choice options. The selected choices of design options comprise pre-selected items provided by one or more commercial sources with the pre-selected items being thereby marketed to the consumers.

### FIELD OF THE INVENTION

This invention relates to customer and builder displays of selectable design options with photographic real life accuracy and particularly displays of actual sites and more particularly using such displays to drive marketing of the selectable design options.

### BACKGROUND OF THE INVENTION

Currently customers wishing to decorate rooms or houses and are wishing to depict renovation possibilities utilize base models ranging from cut and paste options to CAD imaging modifications. Colors are often imagined with swatch samples and different views and angles are often imagined as well.

### SUMMARY OF THE INVENTION

It is an object of the present invention to provide an e-commerce business system including a personal design center enabling accurate depiction of customer selected choices of design options overlaid on existing rooms, buildings and the like, with color display and with selectable groupings of options.

It is a further object of the present invention to provide such depiction with options for different views.

It is yet another object of the present invention to provide such system online on the internet with central design advisory functions and with pre-sale advertising options.

It is still yet another object of the present invention to generate marketing and sales of depicted items through real life visualization

These and other objects, features and advantages of the present invention will become more evident from the following discussion and drawings in which:

### SHORT DESCRIPTION OF THE DRAWINGS

FIGS. (Drawings) 1-24 depict various décor options for a kitchen, as indicated;

FIGS. (Drawings) 25 and 26 are “before” and “after” pictures of a building and its proposed renovation respectively;

FIGS. (Drawings) 27-29 are samples of the Real Estate Listing Enhancement System showing possible renovation options of listed buildings; and

FIGS. (Drawings) 30-35 depict the stepwise construction of a floral arrangement.

### DETAILED DESCRIPTION OF THE INVENTION

Generally the present invention comprises an E-commerce Epicenter Business System based on a Personal Design Center. The Personal Design Center comprises a visual overlay imaging computer system that includes a user interface permitting the user to choose an overlay photographed image of an actual home product and place a modified version of the image over an existing room image to see how the product would look applied in the room. This may be done with many different products in the same room. Each previously selected image will stay displayed so that future product selections can be viewed together with previous choices, so as to apply a real-life pre-viewing of style and color coordination between all of a room's furnishings.

It can be applied in many different ways, examples of which are itemized below. Most of the methods and systems work in concert with each other and feed each other, thereby building a central epicenter where different industries can display their own modified products in a room setting and simultaneously market items from other non-competing industries, thus enhancing their own items and at the same time generating advertising fees or commission from the other non-competing industries. Cross-advertising with the related systems provides more effectiveness and greater economy by enabling marketing of non-competing industries' products.

In accordance with the present invention, a real life depiction such as of a room, a house, a floral arrangement and the like is modified by computer with realistic and consumer selectable visual or decorative optional changes of colors, designs, appliances and the like. The imaged items are tied to one or more commercial vendors or manufacturers whereby consumers can realistically visualize decorative changes to thereby enhance marketing of items used in the modifications. Examples include room, such as kitchen renovation, real estate marketing, home building and the like.

Builders Personal Design Center

A first embodiment includes a technique and method for implementing the Personal Design Center for home builders. It allows builders to promote the upgrades they wish to sell to potential and present home buyers, by showing them how certain specific selections, with regard to multiple applications, will coordinate with each other in a room setting.

To start designing a room, customers begin by selecting one of the many category tabs shown. They can choose from a variety of categories-cabinets, countertops, appliances, flooring, and more. After clicking on a tab, they choose a subcategory to bring up its swatch palette. The swatch palette is where buyers begin customizing their room. Clicking on a swatch will apply it to the image shown in real-life. To view a product's details, they simply hover the mouse over a swatch. Once satisfied with how all the selections' styles and colors coordinate with each other, a customer can save, e-mail, and even print a picture of the room they designed, along with an order sheet of the upgrades they chose. They can later click on “Open” to view their rooms or compare them in a slideshow, or “Delete” and erase any room combination they may have ruled out. They can even open their saved room on the retailer's showroom computer, and see and feel the physical swatches there, before actually finalizing on them.

This is accomplished by first collecting a digital image database of the various upgraded options the builder wishes to promote. Then the images are modified, positioned, and layered on top of a fixed background of a specific room setting with an automated system that was created and called puzzle-piece logic.

Accessible online, through a link at the builder's design center's kiosk or office computer, the system will initially display a template of a room the builder wishes to include, with or without any upgrades. The buyer is given the ability to see it “virtually installed” in the room by merely clicking on the selection. Multiple applications (cabinets, flooring, counters etc.) can be selected simultaneously so that all the selections will be viewed together. The customer will not realize he has linked into a central site for it will appear as part of the builder's website.

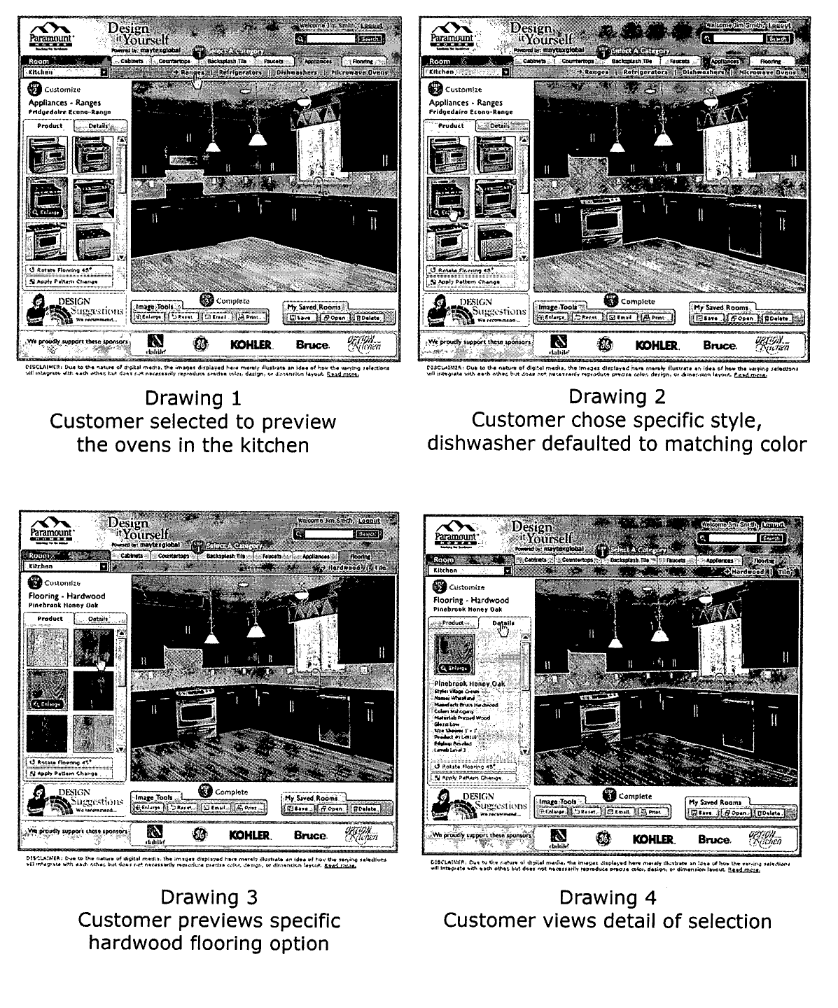

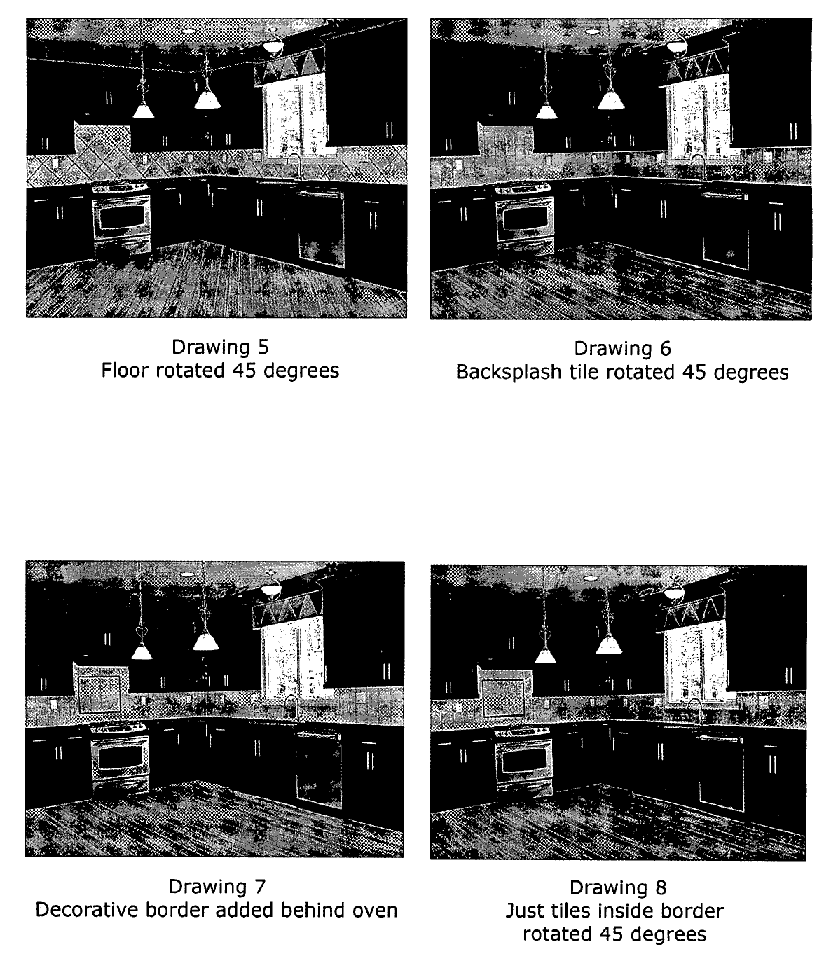

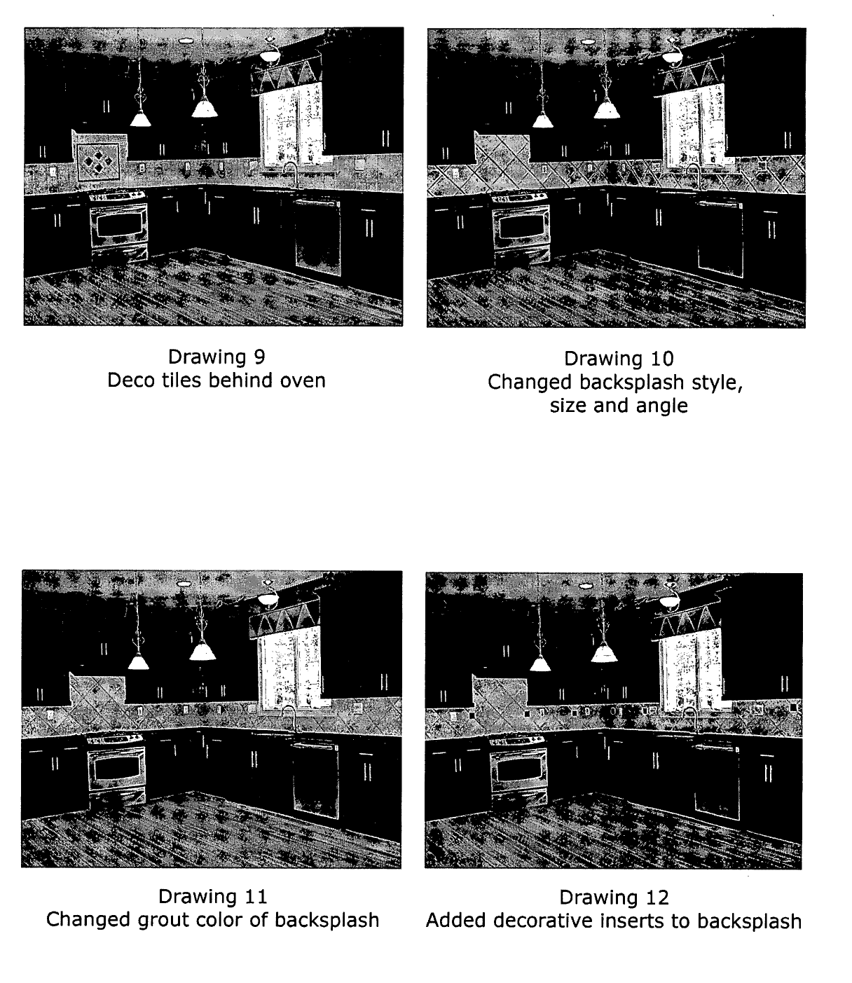

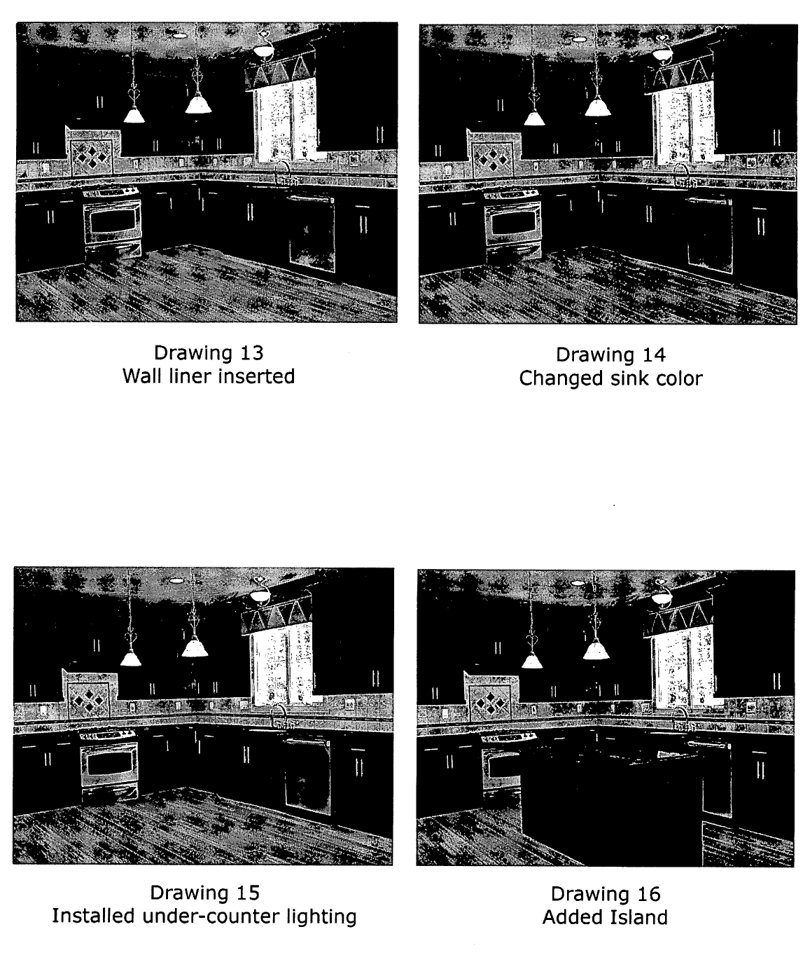

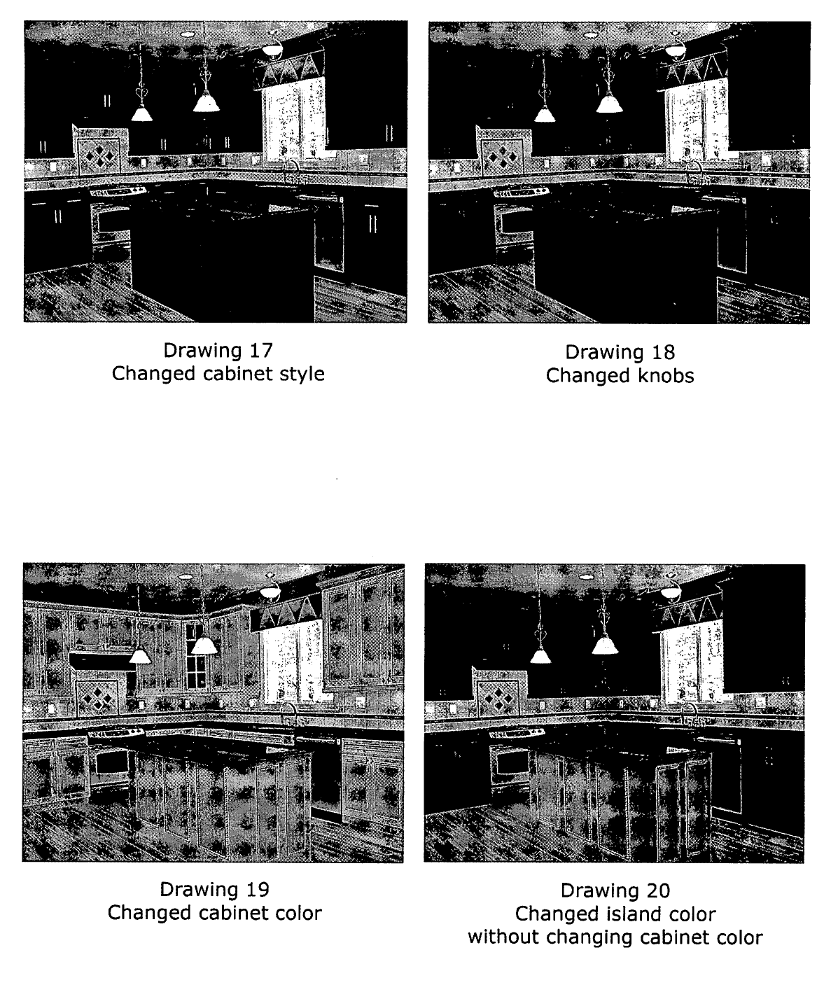

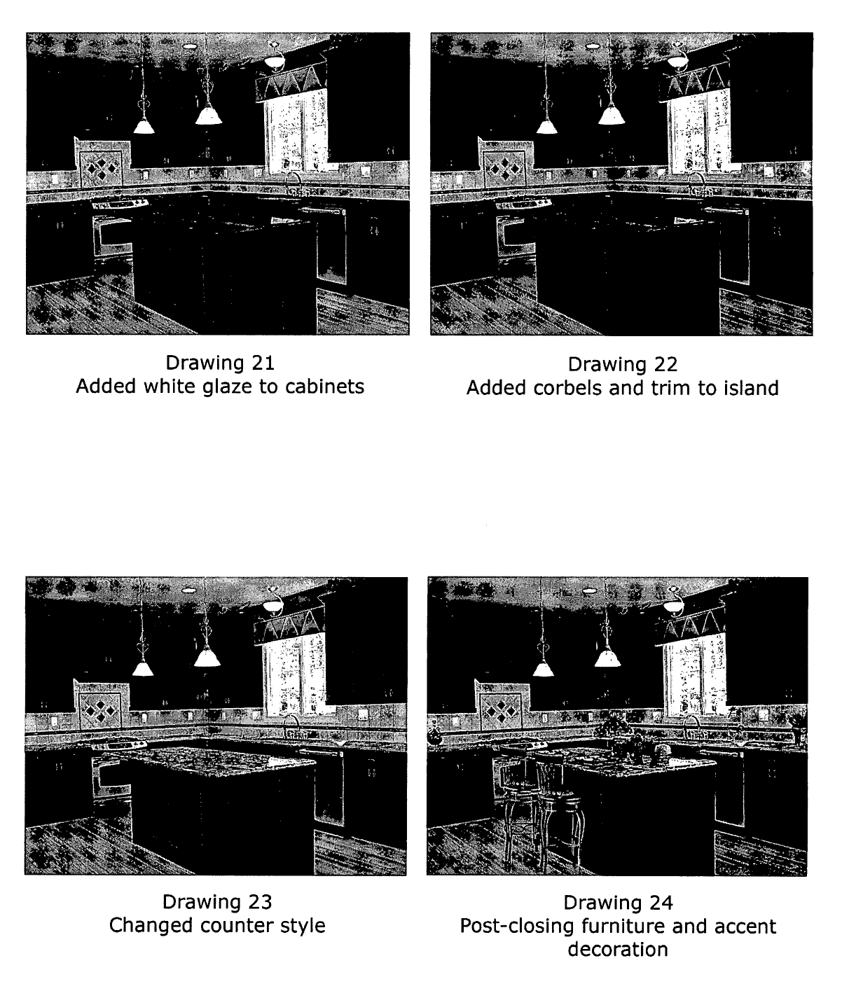

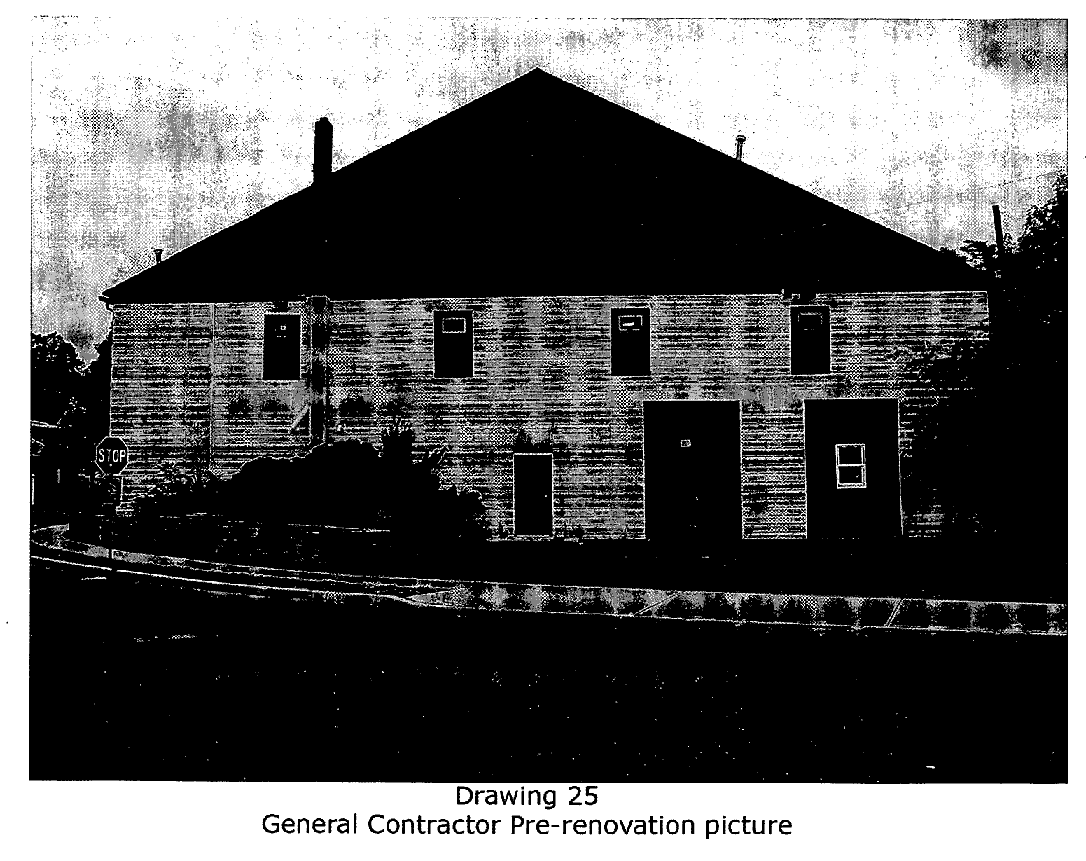

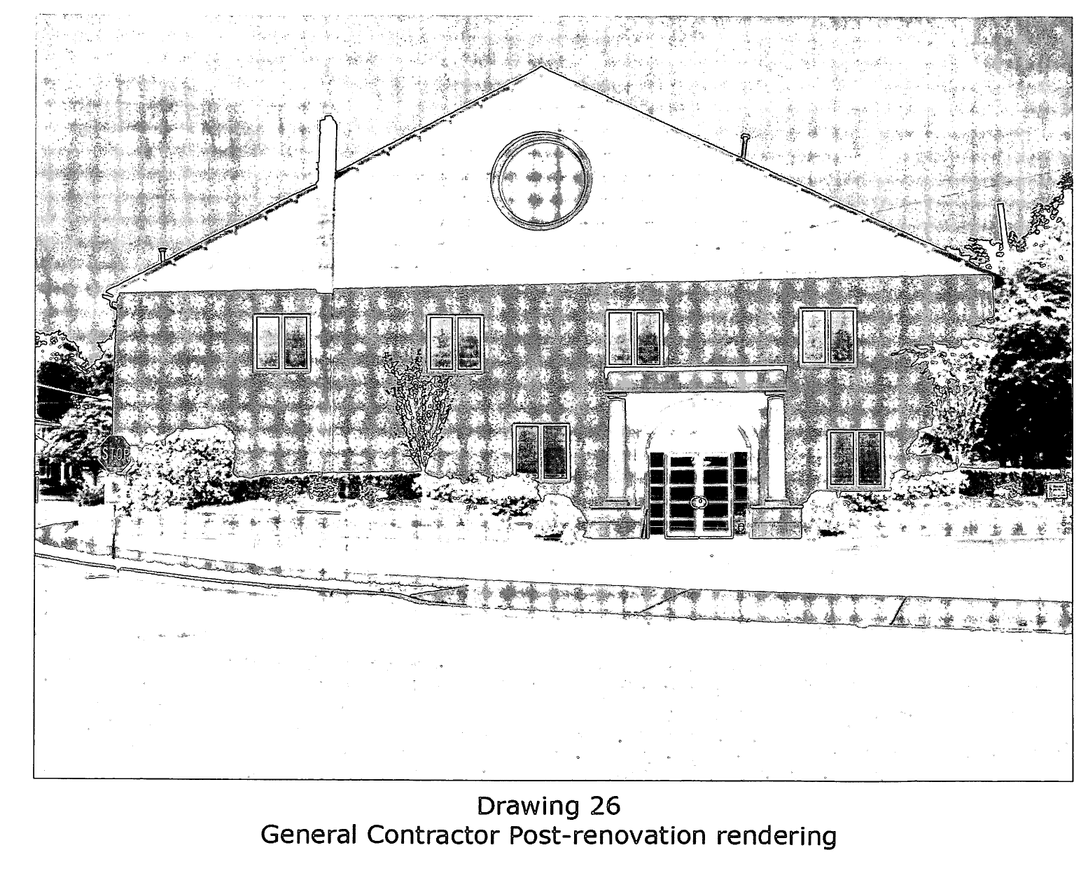

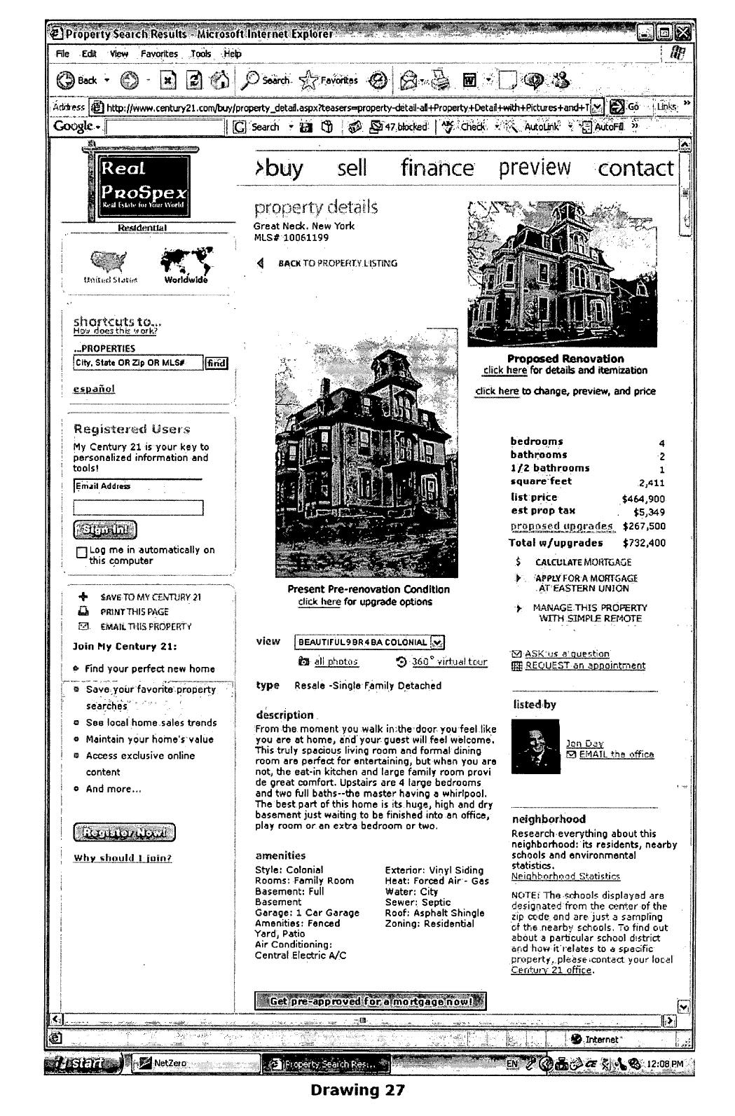

Applications in a kitchen setting include kitchen cabinet styles, kitchen cabinet colors, cabinet glazing effects, cabinet knobs, island viewing, countertops, floor tile, backsplash tile, decorative tile and accents, grout color, appliances, oven hoods, faucets, sinks, lighting fixtures, window treatments etc. Clicking on a selection icon will not only virtually redecorate the room, but all pertinent information regarding that item will be displayed, including a large image of the item, manufacturer, style number, dimensions, color scheme, amount of years the item is under warranty (if applicable), etc., and if the builders so desires, a link to that item on the manufacturer's website for additional information. FIGS. or Drawings 1-24 depict various options being added and/or modified in an existing kitchen. In order of the kitchen renovations, in FIGS. 1-24, are shown with mix and match of styles and colors of ovens and dishwashers (FIGS. 1 and 2). Flooring options are shown in FIG. 3 with details of selection in FIG. 4. FIGS. 5 and 6 show rotational views of floor and backsplash and with a decorative border added behind the oven in FIG. 7. FIG. 8 depicts tiles inside the border and rotated 45 degrees. Decorative tiles are shown in FIG. 9. Changes in backsplash style, size and angle are depicted in FIG. 10. Grout color is changed in FIG. 11 of the backsplashes and decorative inserts are added in FIG. 12. FIG. 13 shows a wall liner being inserted. FIG. 14 shows a changed sink color. FIG. 15 depicts the installation of under counter lights and FIG. 16 shows an added island. FIG. 17 is a changed cabinet style with FIG. 18 showing changed knobs. Changed cabinet color is in FIG. 19, and FIG. 20 depicts changed island color without change of cabinet color. FIG. 21 provides added white glaze to the cabinets, while FIG. 22 shows added corbels and trim to the island. FIG. 23 is that of a changed counter style and FIG. 24 embodies post-closing furniture and accent decoration.

With tiles, customers will be able to change tile angle, or change the tile layout pattern. Customers will be able to see how decorated tile or different colored tiles will coordinate with a main tile. Also, a customer will actually be able to set a pattern of decorated tile virtually to his or her liking. Once a main tile is chosen and “installed”, he or she will be able to simply pick a second or third color or style and play around by placing one tile “here” and one “there” to see how the overall effect would look in the room. Alternatively, the customer will be able to click from a roll-down “Preset Pattern” menu, displaying various pre-set pattern options (Checkerboard, Diagonal Diamonds etc.), and the tiles will be automatically patterned accordingly. This would be done even with tiles of different shapes (rectangle and square etc.).

In accordance with the present invention, customers will have the ability to enlarge, save, e-mail and print the final images along with a list of their final selections that can be e-mailed to a builder for ordering and quick reference. Pre-decorated rooms will be available so that a most impressive (and profitable) combination of upgrades will be automatically displayed under a “We Recommend . . . ” button. A central site is programmed so that once a customer saves a selection to such site, an e-mail will be sent to the builder's Sales Department so they can follow up.

Customers will have the ability to request live interior-decorator counseling, wherein available interior decorators e-mail back to the customer virtual rooms, decorated according to suggestions, based on the general taste exhibited from their other selections. In one embodiment a customer uses a handheld scanner to scan the barcode of his choices on the showroom floor, after which he plugs it back in the computer where he will see a slideshow of his room displaying all the choices he and the salesman picked.

When a high-ticket item swatch is clicked on, an audio clip of a salesman pitching the benefits of the product depicted on the swatch selected will be played. The customer will have the ability to mute the audio. Here too, manufacturers might be offered sponsorship so that their items are pitched, while other items are merely viewed.

In a more advanced embodiment, when a customer saves a room into his account, he will be prompted with a survey. The survey, as well as the user's saved rooms will be sent to a central office in order to judge their style and tastes. The central office interior decorator would then modify or recreate the user's saved room professionally, and send an email to the user notifying them of the newly designed room, which will be stored in this user's Saved Rooms window. The e-mail would have the new picture included. The user would then click on it and go directly to the saved room, where he will see the professionally designed room, and will have the ability to immediately tweak it further to his taste.

Small builders without design centers will find great value in that this can replace a brick-and-mortar design center which is financially out-of-range for most small builders. Conventional design centers on average add 13 percent to the price of a home through options and upgrades-that means between $35,000 to $40,000 in add-ons to the typical home purchase, and can lead to a potential 60 percent increase in amenity sales. It also eliminates 10 days from the building cycle, and saves sales staff time by as much as 50 percent, according to one industry expert. Large builders who already have design centers will also benefit from the time saved in the building cycle and time saved from the sales staff. It will complement their existing design centers as it will offer powerful previewing capability just of their most profitable products. Designing their rooms on line at home, buyers will come to the design center educated in the items the builder wants them educated in. As opposed to the present artificial CAD-image based programs, this is not merely a product placement tool, but its real-life imaging has the power to promote a certain product, and offer near-perfect color coordination. This power to promote a specific product can benefit the builder who wants to push that item, and also benefits the manufacturer who is sponsoring the product. Manufacturer sponsorship is discussed below.

A general contractor's version may be created, which is based on the above, just tweaked for construction contractors who would want to show potential home-owners how certain renovation projects will look on their home as shown in FIGS. 25 and 26, as “before” and “after” depictions. Contractors will be able to show one-by-one how different projects such as facade, roofing, windows, shutters, landscaping, lighting, additions or any exterior or interior work will affect the look of their home before actually doing the work. Here too, homeowners are given the ability to change their selections online with any of the sponsors' material in a central database. Again, manufacturers' items will be displayed, based on the contractor's plan level. Custom rendering will be offered as well and charged on a per-job basis, depending on its technological difficulty.

Individual homeowners are offered the capability to send in images of their various rooms, indicating proposed areas to redecorate. The appropriate areas are rendered at a central site so that the customer can apply any of a sponsors' merchandise to his image. A code may be embedded in the image so that the item the customer selects will automatically be modified to the correct size, angle, and perspective to match that particular room setting.

In an embodiment, Epicenter Design Studios, adapted to display the present system, will contain “showing rooms” with large plasma screens so that clients and their designers can sit and preview and discuss their various sponsored selections in impressive, high-quality detail. Manufacturers/retailers can buy or lease premium physical showroom space in the center to display their wares so that customers could physically see and feel their more popular selections. Local retailers and designers, especially those with showrooms in the area, will pay to have their preferred merchandise available for display. They will be able to give a customer a password and have his specific options display, so that when the customer puts in the password, he will see whatever the retailer wants him to see. This will be used for builders, and for post-closing, and renovation.

Builders and general contractors will be offered to choose from one of the following plans. Besides charging a base fee and maintenance fee, each product category will be priced separately:

Builder Standard Level: A link is placed on a builder's website to a central site but branded with the builder's name, utilizing only a manufacturer-sponsored database, displayed in the order and prominence of a tiered manufacturer sponsorship system. The builder can decide to use the central database for everything besides kitchen cabinets (for example) and pay just for a higher level for this industry. Every industry will have its own price list.

Builder Silver Level: Same as above, just the builder will be able to determine the order of which products come up first.

Builder Gold Level: The builder could choose to have a centralized office install the upgrade options that they profit from the most, items that are not already in the central database. These options will come up first on the selection palette and the manufacturer-sponsored items will come up afterward. Besides costing more for the program, they would be charged a service fee per item installed.

Builder Platinum Level: The same as above, just no other manufacturers' merchandise will be available for display.

II. Manufacturer/Retailer Website, Standard Level:

A link is placed on a manufacturer's website, branded with its name, utilizing only its products for its category. When accessing the central site through, say Daltile's link, a customer will only be able to see Daltile's tile together with all sponsored manufacturers' cabinets and appliances etc., so long as they are from a non-competing industry. Here too, high level sponsors get first exposure. Highest sponsors will also have their coordinating products automatically installed and viewed as each matching tile style is selected.

Manufacturer/Retailer Website, Gold Level: Same as above, just other non-competing industry merchandise and contact information will be available for advertising only after the original purchase is made.

Manufacturer/Retailer Website, Platinum Level: Previewing of manufacturers products in room setting, but no other industries will be available for advertising.

III. Mobile Design Center: A centralized office will provide a “design center on wheels” offering one of the above levels of service with a complete mobile unit containing a laptop with a proprietary system, together with a display where the physical swatches of tiles, counters, cabinet colors etc. are packaged together in a user-friendly kit.

IV. Virtual Design Kiosk: A Virtual Design Kiosk will be offered to provide a computer booth/kiosk meant to fit in a trailer or model home with all sponsored physical swatches and color palettes displayed around the computer, in a neat and organized fashion. All the swatches would have a barcode sticker so that by simply scanning the code with a scanner pen, the item will be “installed” immediately. An entire kitchen can be virtually built and felt in minutes, along with a printout and shopping list for the builder. Also, a slideshow of the room decorated with all the scanned selections can be played.

2. Manufacturer Sponsorship. Manufacturers would pay to have their products in a central database so that all phases mentioned here, including builders (both mid-construction and post-closing, see “Redecorating Product Coordinator” below), designers, renovators, general contractors, private DIY homeowners and retailers and manufacturers of non-competing industries, will show customers their merchandise for previewing. Manufacturers paying the highest level of sponsorship will get premium exposure; their merchandise will come up first and most prominently (larger icons and perhaps links to their own website).

Kiosks can be installed in a sponsors' showroom, focusing especially on multi-application centers like Home Depot so that a customer can simultaneously view Home Depot tiles, window treatments, kitchen cabinets, carpets, appliances etc. in the store or at home. Home Depot gains not only in-store, but by sponsoring the central system database, standard-level and gold-level builders, contractors, designers and DIY homeowners will be showing their customers Home Depot's merchandise on their computers or in their design centers or websites. Also, while a customer might have come in to Home Depot just for tiles, once seeing what a matching (and expensive) Home Depot light fixture etc. will do to the room, he might buy those items too. The coordinating fixture etc. will come up by default automatically once the matching tile was selected or saved.

Sponsored swatches and tiles in the design center/showroom might have an eye-catching sticker proclaiming something like “VIRTUALLY PREVIEWABLE” along with a number and barcode. (This is another subtle way a sponsor's tiles will be promoted over the competitions'.) The product number or name is placed into the computer and the tile is then displayed. The barcode will be used for stores that utilize a scanner pen.

Different Levels of Manufacturer Database Sponsorship:

Platinum Level: Merchandise comes up first for standard level builder members, and second for gold-level members.

Silver Level, 1, 2, 3 etc.: Merchandise comes up successively after Platinum-level items are shown. (A tiered system is offered to a number of manufacturers, with each higher position on the palette costing more. The more a customer has to scroll down the palette to access, the less expensive sponsorship is.)

Standard Level Merchandise comes up only when accessed through the manufacturer's own website. It may also be accessed through standard and gold level members' websites when the sponsor's name is typed into a “Find Manufacturer” window.

Home Page Logo Display: Brand logo advertisement sponsorship on bottom of home page will be offered as well.

3. E-commerce Epicenter Member: Any builder, retailer or manufacturer who opts into the Epicenter Program will be charged less for the service (or might not be charged at all). He agrees however to pay a commission of a certain percentage for each item ordered through a central link. However, any non-competing item that is accessed and ordered through their link gets them a commission of a part of the provider commission so that the commission is shared between them. So if a customer is ordering a cabinet using ABC Kitchen's website, and when viewing GE's appliances centrally matched to his cabinet selection, decides to purchase it, ABC Kitchen will make say, 3% of the appliance sale (and the central provider will make another 3%). This should create a “Web” of all the non-competing manufacturers working with, and feeding each other.

Alternately, instead of getting commissions, members can simply join a web of cross-marketing sponsors. Meaning, ABC Kitchen as an Epicenter member will be willing to display GE's products along their kitchen cabinets. In return, GE, who is also a member, will be willing to display their appliances in the setting of ABC's kitchen cabinets. Profit can be generated either by membership, or by tracking the thread that leads to the purchase and getting commission.

4. Epicenter Independent Website: Once traction is attained in the market, a central web-site can be created where all private customers, designers, etc. will have free access so that they can build what they want using sponsors' complete database. It will be one central “mall” enabling the building of any room or exterior, and allowing the application of clothing and other applications mentioned below.

A universal industry standard for photographing each particular product's angle, distance, lighting condition and resolution will be created in order to expedite the database modification process. When companies are digitally photographing the merchandise for their own websites and catalogs, they will take an additional picture as well at the centrally suggested specifications. Ovens will have their standard, angle and distance, sinks another, and so on. That way, implementing into a central system will save time and money and improve image quality.

Post-Closing Personal Design Center

The above homebuyers can be allowed to decorate their previously saved rooms with products not offered by the builder (e.g., see FIG. 24). Home-decoration-related retailers will sponsor their merchandise on the central system so that customers can decorate their home with furniture, window treatments, wall hangings, table accessories, landscaping and anything the builder did not offer. Once finalizing a selection, the buyer will either be directed to the sponsor's website, or will make the purchase through the central site (or maybe the builder). The builder may be offered a percentage of the commission if he allows these retailers to display their products for sale before closing. This way, more expensive selections might be purchased because its cost would be absorbed by the mortgage.

For items like tiles, besides displaying price per tile, price per square foot, the total calculated cost per room size indicated, the monthly charge for that item based on mortgage rates, and an estimate of the final cost would be displayed, including installation fees based on a local installer who services the area within the area code provided.

Central office interior decorators would access homebuyer's saved rooms and virtually decorate them with items not offered by the builder. Homebuyers would then have these images and product information emailed or mailed to them. This is innovative advertising, at its most powerful level-it is the equivalent of walking down the street and seeing in the window of a store that you have shopped in, a stunning designer-picked suit, on a model of yourself.

Redecorating Product Coordinator

In this phase, individual homeowners wishing to renovate their homes would have the ability to take a digital picture of their room, and upload it to a central website for free. With a small picture of their room open in the corner, they will choose one of a few of the preset rooms that look most similar to the layout of theirs. They will then color cabinets (for example) the same color as theirs by utilizing an eyedropper tool, sampling first their cabinets, and “painting” the cabinets the same color by simply clicking on the preset cabinets. They then choose from a library of the closest cabinet style to theirs (there are only a few mainstream cabinet styles out there). They then color-match the tiles, paint, etc. until the preset room matches the colors and basic style of their room. They could then shop for whatever they want by “installing” their selections using the sponsors' database of lighting fixtures, furniture, appliances, tiles, paint etc. Here they will be asked to include the room size along with their zip-code so that area retailers and installers will have their estimate and contact information displayed with each selection. Customers will be able to buy the selection centrally online or through the retailer advertised. Besides offering manufacturers the above mentioned prioritized space on the selection palette, profit will be generated by offering the following:

I. Retailer, Renovation Level 1: While a customer is selecting say, tiles, from the selection palette, non-competing retailers can be offered the ability to display their merchandise in the room setting. Retailers can be charged on a per-item basis. Different manufacturers' items will be displayed at random, no matter what style room is chosen. Fees will be percentage based-with an offer of, for example fifty slots, meaning that a particular item will be displayed every fifty clicks for non-reserved room settings (see below). A retailer could buy more slots for more exposure or all fifty slots for exclusivity. Every location (e.g. countertop corner, spice rack, island floral arrangement etc.) will be charged separately.

Retailer, Renovation Level 2: Same as above, but item will be linked to a specific room setting (to be determined by retailer). Whenever a customer chooses that specific style setting, that specific piece of furniture (or whatever) will be displayed by default. Only a limited number of settings will be available so that Level 1 remains a worthwhile option.

Retailer, Renovation Level 3: Retailer reserves exclusive rights to a complete product category. Other competing retailers still have the capability to show their merchandise with the central system, however only on their own website.

II. Area Installers: Sponsorships and advertising may be offered to local installers of applicable selections. Besides incorporating the installers' price into the above-mentioned applications, his contact information will display as well.

Real-Estate Listing Enhancement Program

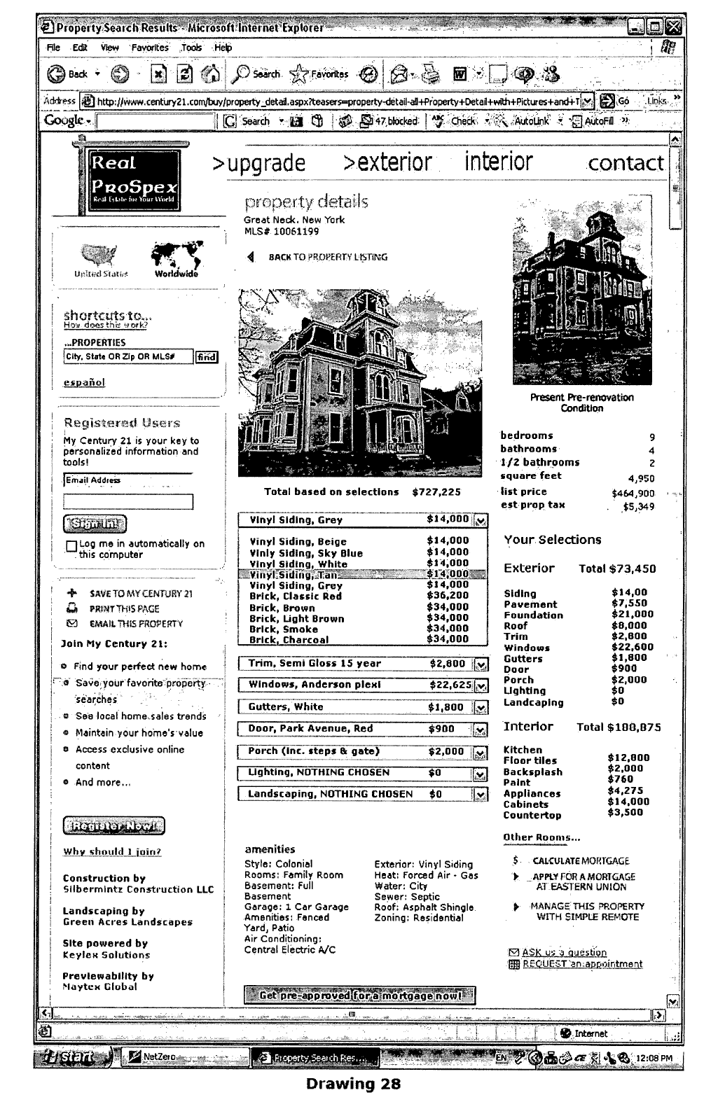

Homeowners wishing to sell their homes who list their homes online and who want to improve their homes' image on their online listing picture can have a central office virtually renovate their homes. The home-listing company will display two images of the homeowner's house. One present, pre-construction, and the other post-construction, renovated virtually. Associated contractors will work in conjunction with central office graphic artists and provide estimates based on seeing the actual project and the virtual sketch. Both the present and the proposed post-construction prices will be included in the listing. Here too, potential buyers will be able to change selections independently, and the final price will automatically reflect the changes as they are clicked on (see FIGS. 27-29).

Real-Estate Listing Enhancement Program-Option 1

The homeowner can be charged a fee for rendering the entire exterior and perhaps parts of the interior of a house, and link up with a construction company to implement their merchandise into the upgrades that are displayed. The above-mentioned manufacturer sponsored database will be available here as well. Teaming up with a major Realtor like Century 21 or Remax, the central office could then act as middlemen for major general construction companies, landscapers, home construction loan officers etc.

Real-Estate Listing Enhancement Program-Option 2

Alternatively, this service may be offered for free, but splitting the profit of the upgrade. Meaning, if the seller was going to sell it un-renovated for $400,000 and is selling it now renovated with the centrally generated system for $550,000, the upgrade is configured to include a cut for the central office and the seller such as, for example 5% of the $150,000 upgrade ($7,500) would go to the central office, the seller would also make 5%, and the construction company would make the remaining $135,000 for their work.

Personalized Floral Arrangement

Teaming up with a company like FTD, it is possible to tweak the system of the present invention by allowing a customer to arrange a custom-made floral arrangement from their home computer, thereby personalizing a gift which should really be personalized and not just paid for and arranged by a stranger. The customer can be charged centrally or by FTD or the florist. FTD or the florist would be charged either a flat fee for using the present system, or per order. The florist will get a detailed list of the flowers the customer ordered, along with a picture of what the sender envisioned making.

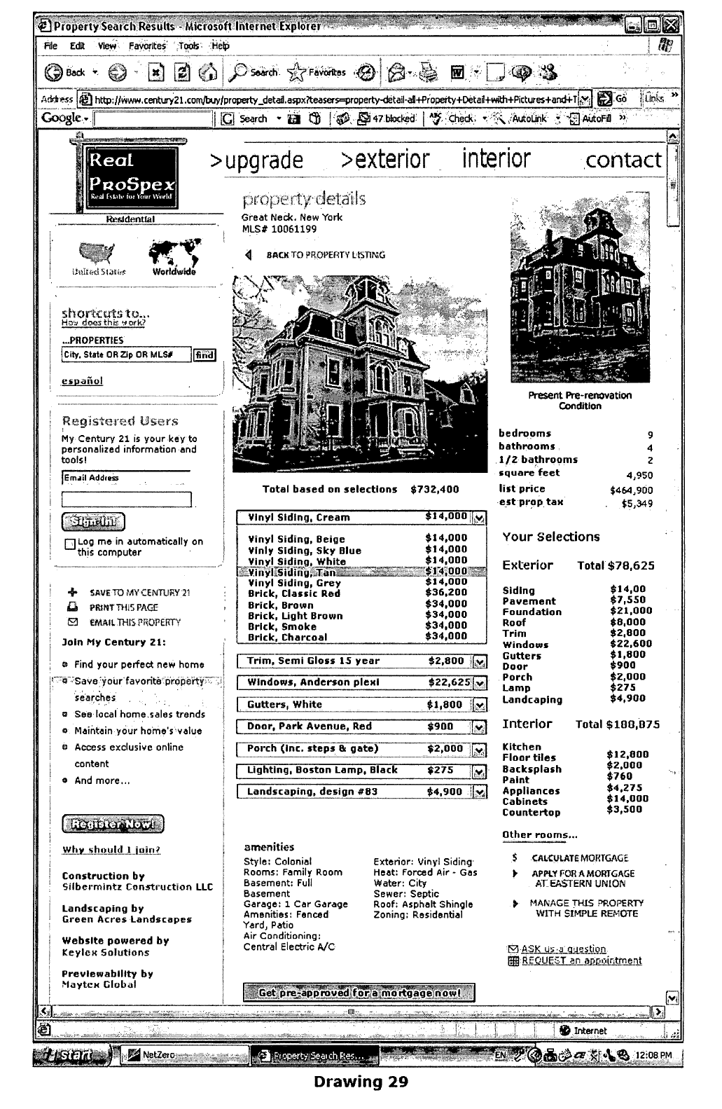

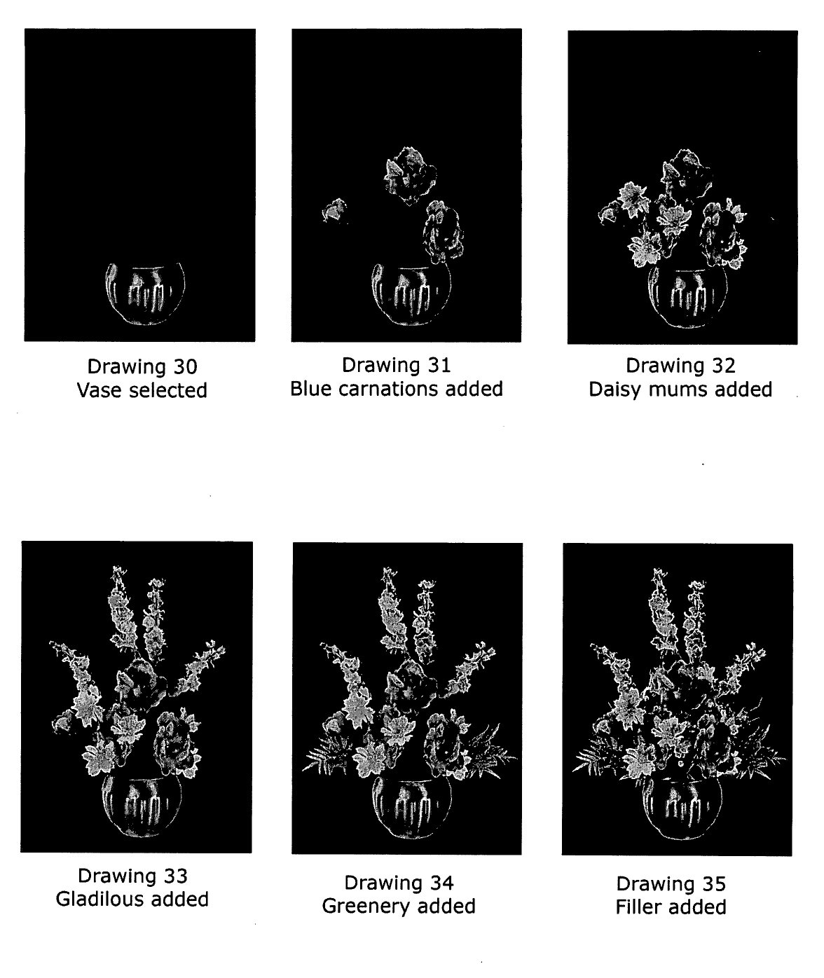

Final charges will include a line which is checked off by default stating “Replace out of stock flowers with similar ones without confirmation-deduct $5.” If the customer is particular he can uncheck the box and pay the extra $5, so the florist can email back a list and image of any replacement flowers he might include. The customer can either confirm the change or replace the flowers with ones he likes. (See FIGS. 30-35.)

Applying Above to Non-Home Design Markets

The system allows previewing of home décor, including tiles, carpets, rugs, paint, window treatments, landscaping, entry doors, wallpapering, moldings, borders, ceiling tiles, kitchen counters, furniture, lighting and bath fixtures, linen, mirrors and shower curtains, and can be applied to practically all home products. It can also be used to match frames to artwork or pictures.

People can upload images of themselves, to be used for eyewear, makeup, clothing, wigs, hairstyles, cosmetic and orthodontic surgery etc. All applicable phases above will be applied to this area. The following “central site” option will be included as well.

When first registering with the central site, a consumer will create a username and password. He will then go through a profile process. So as to facilitate his future shopping, he uploads various pictures of himself and his family, posing and marking his various coordinates according to instructions. Once all this information is in, his profile is kept under his username so that he never has to go through this process again.

Here is an illustration of a registered member purchasing a pair of glasses. She is not interested in lugging down to the stores, trying on every single style there is. She logs onto the central website and types in her username and password. She clicks on the “Fashion” tab, and then on the “Eyewear” tab. She puts in the miles she is willing to travel, and her price range. A front profile of her face (which she entered during registration) shows up on the screen in big. She can then choose either “Slideshow”, where she will see herself every three seconds wearing a different pair of glasses from the latest styles, as their names, price, and other pertinent information is displayed on bottom. Or if she likes, she can try on countless pairs at her leisure (as explained above by home products), without bothering any salesman and without the pressure of any salesman on her. The glasses can be categorized by color, style (rimless, plastic etc.), price or company and she can check off all the styles that she is considering and afterwards compare them side by side or in a slower slide show. Optometrists etc., in her area will be advertised on the side. After choosing the glasses she likes, she prints a receipt with the information and brings it to the nearest sponsored store that has it in stock to purchase it.

If the retailer opts into the present Epicenter System, the customer will also be seeing herself wearing different earrings and necklaces, clothing, makeup, furs etc, while the glasses are being viewed.

It is understood that the above examples and drawings are illustrative of the present invention and that changes in applications, modification options and the like may be made without departing from the scope of the present invention as defined in the following claims.

What is claimed is:

1. A marketing system comprising a personal design center having means to enable depiction of customer selected choices of modified parts of actual photos of design options overlaid on existing reality images with color display and with selectable groupings of the customer selected choice options, wherein the selected choices of design options comprise pre-selected items provided by one or more commercial sources with the pre-selected items being thereby marketed to the consumers.

2. The marketing system of claim 1 wherein the reality images are selected from rooms with options for room décor, buildings with options for architectural design options and personal adornments and appearance options.

3. The marketing system of claim 1, wherein said means to enable accurate depiction of customer selected choices of design options is contained in a central location with access thereto through the internet and wherein the central location is further adapted to provide advisory functions to assist a customer in making the selected choices.

4. The marketing system of claim 1, wherein the system comprises means for the customer to directly order the selected choices from the commercial source.

5. The marketing system of claim 3, wherein the advisory functions comprises the counseling of professional decorators.

6. The marketing system of claim 1, wherein the customer is a builder and the design choices comprise select building design elements with different visual appearances.

7. The marketing system of claim 1, wherein the selected choices provide a marketing visualization of multiple items from different commercial sources as visually appearing in juxtaposed conjunction with each other.

8. The marketing system of claim 1, wherein the customer selected choice options provide a real life visualization of a prospective renovation.

9. The marketing system of claim 8, wherein the prospective renovation is that of a room or a building.

10. The marketing system of claim 8, wherein the customer is a general contractor and wherein the selected choice options are marketed to the contractor for use in a project of building or renovation by a virtual visualization of a completed project with interactive appearance coordination of commercial products.

11. The marketing system of claim 1, wherein a photographic depiction of an existing reality image of a real site to be decoratively changed is used to provide a base for the customer selected choices of design options.

12. The marketing system of claim 11, wherein the photographic depiction of an existing reality image comprises a real estate site and wherein the customer selected choices of design images comprises visualized renovations to help market the real estate site by providing visualization of availability of possible changes to the real estate site.
